(19) United States
(12) Patent Application Publication
(10) Pub. No.: US 2006/0053457 A1
(43) Pub. Date: Mar. 9, 2006

(54) Module, system and method for processing digital signals

(75) Inventor: Philippe Guenebaud, Saint Cyr Sur Mer (FR)

Correspondence Address: YOUNG & THOMPSON, 745 SOUTH 23RD STREET, 2ND FLOOR, ARLINGTON, VA, 22202, US

(73) Assignee: Neotion SAS, La Ciotat (FR)

(21) Appl. No.: 10/537,373

(22) PCT Filed: Nov. 13, 2003
(86) PCT No.: PCT/FR03/50118

§ 371 Date: Jun. 3, 2005

(30) Foreign Application Priority Data
Dec. 3, 2002 (FR) 02/15187

(51) Int. Cl. H04N 7/173; H04N 7/16

(52) U.S. Cl. 725/100; 725/143; 725/131

(57) ABSTRACT

The invention relates to a digital signal-processing module (2) which can be connected to a host (1) for receiving at least one input transport stream of encoded digital data in a pre-determined compression format. The inventive module comprises means of decoding the digital signals contained in the input transport stream. The invention also relates to a system comprising the aforementioned module (2) and to a method of receiving and processing digital signals. The invention is particularly suitable for use in the field involving the reception and decoding of digital transport streams for the broadcasting of audio-visual programmes.

The present invention relates to a digital signal processing module and a system for receiving and processing digital signals.

The invention will be particularly suitable for application in the field of digital television, and especially the receiving and processing of input transport streams supporting digital data used for the digital signals involved in the broadcasting of audio-visual programmes, generally comprising an audio and a video parts.

Digital television has made great strides these last few years whether by satellite broadcasting or terrestrial broadcasting, and especially by cable. The television programmes are dispatched to the viewer by digital transport streams generally consisting of multiplex streams integrating multiple programmes.

Moreover, the data contained in the digital transport streams are generally scrambled to avoid the pirating of paid TV programmes.

In addition to the scrambling process, the data also generally undergo encoding in a predetermined compressed format such as MPEG2 (Moving Picture Experts Group) or MPEG 4 and MP3 (in the audio field).

The data is generally compressed in these formats to reduce the cost (by limiting the band width for transmission) or by limiting the storage capacities.

The data transport streams are received by the end user through a device which is generally called a decoder or set top box which performs reception, any descrambling, or audio and video decoding, and adaptation of the signals for use (in particular adaptation to the PAL/SECAM format and digital/analog conversion for display on a television screen).

Generally, descrambling involves authorization means which are allocated to the user against payment of a fee. These authorization means are, for instance, supported by a smart card that co acts with a smart card interface integrated in the set top box in order to deliver authorization keys used by the descrambling algorithm used in the set top box.

According to the most usual configuration encountered at present, the set top boxes include various types of TV operators.

This system, which is commonly called DVB descrambler, enables the operators to offer their services through decoders or set top boxes which are standardized in terms of their security. This technology is used in particular for the digital video broadcasting (DVB) standard.

A disadvantage of this common descrambler technology is that the authorization means on the smart card are less able to withstand an attack by hackers. If the authorization means are successfully hacked, a large number of them have to be replaced, without their being any certainty that the newly installed protection will withstand further attacks for very long.

At present, smart cards only withstand new attacks for a few months. Moreover, the set top box is difficult to change as this is an extremely expensive operation and would have to apply to all the set top boxes in view of their common interface.

Moreover, the compression technology used for the digital emissions (MPEG2) is common to all the reception decoders and takes the form of hardware components, and prevents any introduction of new more powerful decompression technologies (MPEG4, H264, etc.) without changing the decoders.

Other types of set top boxes are known for the DVB-CI standard for the common interface and using a conditional access module. In this context, document WO-A-0174075 describes a system that consists of a portable conditional access unit of the removable smart card interface type. This conditional access unit is able to co-act with an intelligent receiver of the set top box type. The intelligent receiver is adapted to receive various types of removable smart card interfaces depending on the operator (such as the operators of digital broadcasting systems).

A smart card is provided by each operator and can be inserted in the removable smart card interface by the user.

A key is supplied by the digital broadcasting system operator to execute an algorithm that will descramble the encoded audio and video data received by the intelligent receiver. The removable smart card interface allows the conditional access units to be interchanged using the descrambling algorithm specific to the operator's digital broadcasting system.

Consequently, the same intelligent receiver can be used by various digital broadcasting operators with different encryption keys and different encoding algorithm.

A disadvantage of these devices is that an unscrambled stream in a compression format (for example MPEG2) can be accessed at the electrical terminals of the smart card interface. This is generally a PCMCIA type interface in widespread use. This connection, which has a very reduced stream (a few Mbit/s) seems to allow pirating and recording of the descrambled compressed stream emitted by the connector.

Another disadvantage of these systems is that they do not allow the creation of interactive services, i.e. allowing feedback from the user's device towards the digital broadcaster's server. Indeed, the conditional access modules or units are not able to receive a full interactivity engine. They do not have sufficient power or memory for this purpose, and above all the command interface does not authorize a stream that is compatible with a truly interactive service. Standard DVB-CI does not envisage this function.

The techniques known to date have many disadvantages in terms of their intrinsic weaknesses in the face of attacks by hackers and also limited flexibility of use. Therefore, there is a need for a system that provides solutions to these various disadvantages.

For this purpose, the present invention has a system which has the advantage of positioning remotely in a movable and replaceable way most or all the essential functions the receiving and processing system.

In particular, decoding from a predetermined compression format takes place inside the external module in order to remove system intelligence to the remote module rather than preserving it in the set top box.

An advantage of the invention is that the module can be replaced and custom defined by the operator. Its resistance to hacking is therefore much higher. Moreover, it offers broadcasters of television programmes greater flexibility as it can be modified or replaced if hacked.

The set top box used according to the present invention has the advantage of being really multipurpose whatever the descrambling or scrambling mode used and the type of compression format to be coded and decoded.

This multipurpose characteristic does not have to penalize the security of the entire system, quite the contrary.

Other applications and advantages will become apparent during the description of a preferred embodiment which follows.

The present invention relates to a digital signals processing module which can be connected to a host for receiving at least one input transport stream of encoded digital data in a predetermined compression format. It includes means for decoding the digital signals contained in the input transport stream.

This module will be presented based on the variants described below:
It includes means for descrambling the scrambled digital signals contained in the input transport stream,
It includes means for authorizing the decryption,
It includes means for prior demultiplexing and filtering the input transport stream,
It includes means for encoding digital signals in at least another compression format for code conversion,
It includes means for temporary or permanent storage of data signals,
It includes means for operating its interface with host,
The input transport stream is a digital data stream transporting audiovisual programmes.

The invention also relates to a system for receiving and processing digital signals comprising a host for receiving at least one transport stream of encoded digital data in a predetermined compression format and a processing module able to be connected to the host.

In preferred embodiments, this system will be such that:
The host includes an interface connecting with processing module, said interface comprising a signal input emitted by a receiving part of host and a signal output towards a part of host for adapting the signal for display,
The interface is operated by processing module,
It includes at least one additional processing module which can be connected to host by interface,
It includes a digital data storage unit,
The storage unit can be connected to host by interface,
The processing module includes local data encryption means for storage on the storage unit,
It includes an digital/analog converter connected at the input to the processing module for additional processing of analog signals,

The invention also relates to a method for receiving and processing digital signals, including a stage for host to receive at least one input transport stream for encoded digital data in a predetermined compression format.

The input transport stream is transmitted from host to a processing module. In the processing module, the digital signals contained in the input data stream are decoded in the processing module. The treated signals are returned to host.

The following supplementary stages are advantageously executed:
in the processing module, demultiplexing and filtering of data input stream take place before decoding,
scrambled digital signals are received in input transport stream,
the scrambled digital signals in the processing module are descrambled,
a storage unit is used to store digital data from the input transport stream,
the digital data from the input transport stream is stored on storage unit,
the digital data is transmitted in a deferred mode to processing module for processing,
decoding of digital data take place in processing module and then encoding in another data compression format,
this transcoded digital data is stored in storage unit,
the digital data of the treated signals is encrypted in the processing module,
the encrypted processed signals are stored in storage unit,
several input transport streams are received,
the input transport streams are transmitted towards processing module,
the treated signals are returned to host for storage and/or display,
at least one additional processing module is used,
decoding is carried out from different compression formats in the various processing modules.

The attached drawings are given as examples and are not limiting. They show only one embodiment of the invention and will enable it to be easily understood.

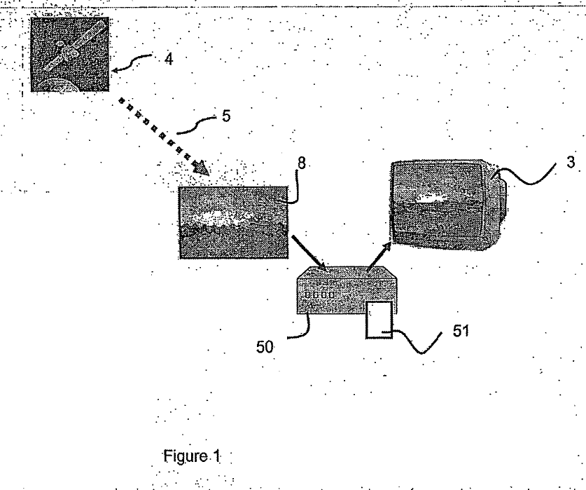

FIG. 1 schematizes the current method of receiving and processing digital data transport streams emitted by a satellite receiver.

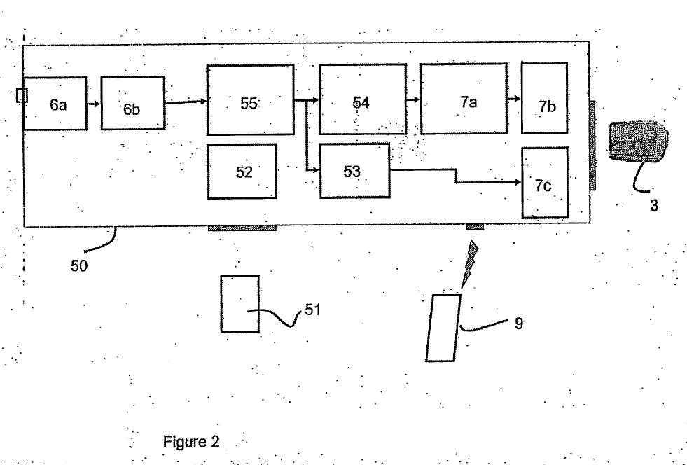

FIG. 2 also illustrates the current state of the art and the various components of the set top box used.

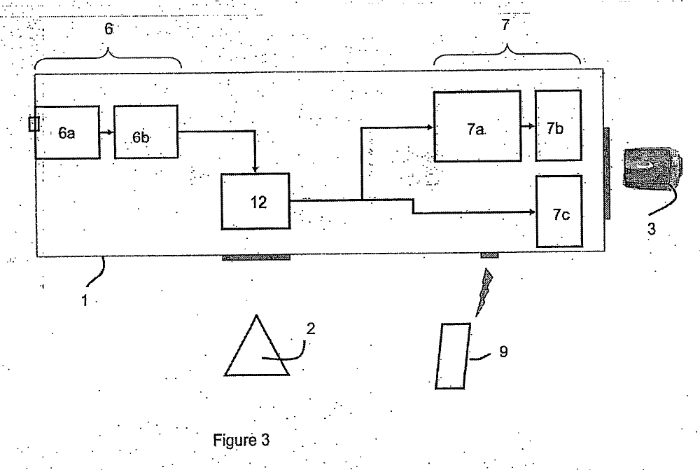

FIG. 3 shows various components of the system according to the invention in a preferred embodiment.

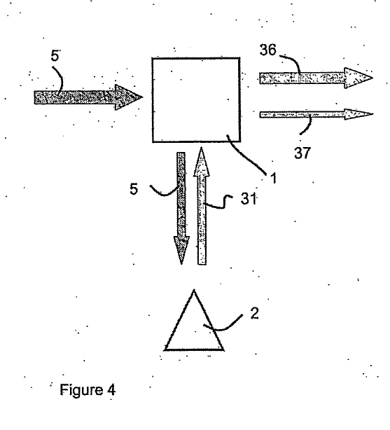

FIG. 4 shows an example of the routing and processing of the digital data transport steams.

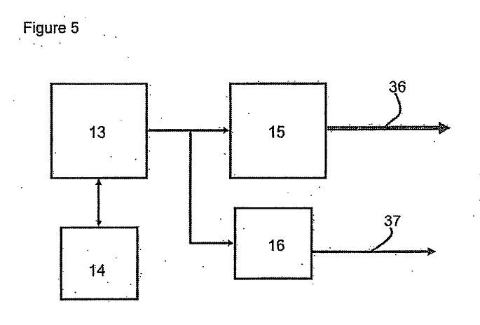

FIG. 5 shows an example of the invention module components.

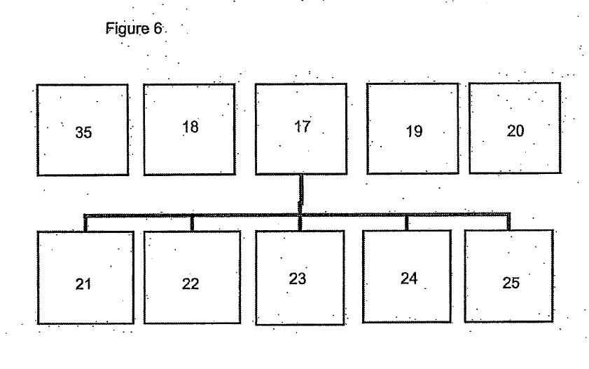

FIG. 6 shows more precisely a possible material implementation of the invention module.

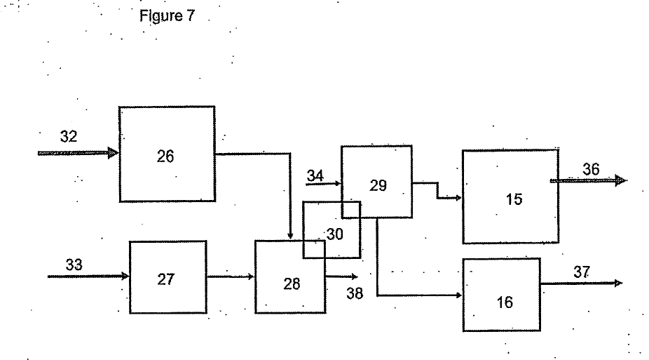

FIG. 7 shows an additional use of the invention for local backup copying of an encrypted data.

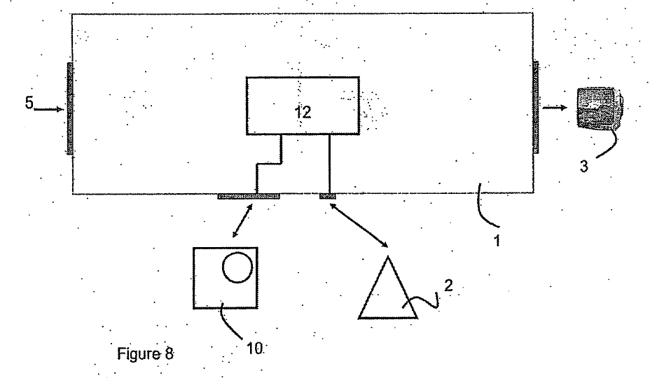

FIG. 8 shows a variant of the invention with an additional storage unit.

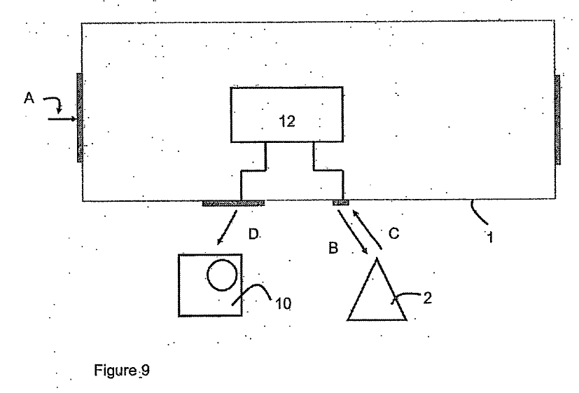

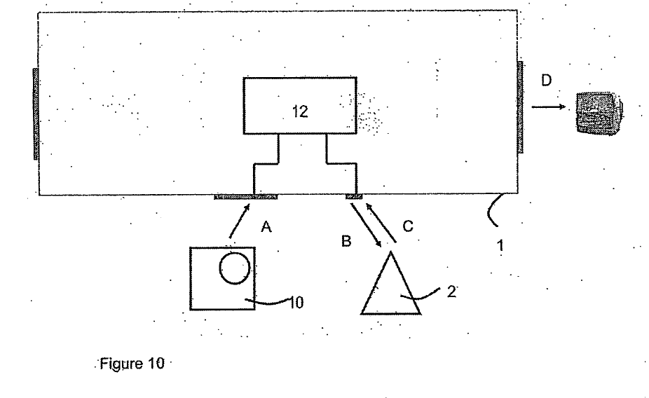

FIG. 9 and FIG. 10 show various operating configurations of the invention according to this variant.

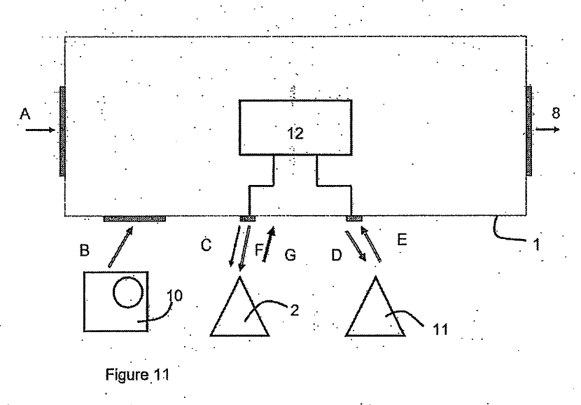

FIG. 11 shows an example of the operation of the invention according to an alternative which uses two modules and a data storage unit.

As a preliminary, it is stated that this description is not limited to a digital television application. The data streams which are processed generally include an audio part and a video part. However, this example of the invention is not limitative.

According to the current state of the art which is shown in FIG. 1, a telecommunication network 4 transmits a digital data stream 5 supporting one or more digital TV programmes from the operator's digital broadcasting server.

Generally, the input digital stream 5 is a scrambled multiplexed stream to avoid hacking and is coded in a predetermined compression format. Reference 8 on FIG. 1 is an example of an encrypted, encoded input signal supported in the input digital stream 5. At this stage, signal 8 cannot be used directly by the user.

The input digital stream 5 is received according to the state of the art in a decoder 50 which is commonly called a set top box. Decoder 50 co-acts with authorization means delivered by the operator to the user which for example consists of smart card 51.

After the authorization means on smart card 51 is delivered to decoder 50, the latter processes the input digital stream 5 in order to obtain signals that can be used, in particular for viewing on a television set 3.

FIG. 2 more particularly presents an example of various components in a decoder 50 according to the current state of the art.

In this context, decoder 50 initially comprises the receiving part, including a tuner 6a whose input is connected to an aerial or an unspecified cable. This tuner 6a is connected to a demodulator 6b so that the demodulated signals are then transmitted to the descrambling system 55 which is able to perform stream demultiplexing. The demultiplexer generally consists of a certain number of filters programmed by a microprocessor based on the various applications supported by the decoder.

Encryption keys are used by the descrambling algorithm at descrambler 55 and depend on the authorization means contained in the user's smart card 51. By means of a smart card interface 52, the user inserts smart card 51, which enables decoder 50 to access the authorization means used by descrambler 55. At descrambler 55 output, the data are organized in packets and are descrambled.

They are then decoded. This consists in passing from a predetermined compression format to a decompressed format. This decoding takes place at the level of the decoders and generally includes an audio decoder 53 and a video decoder 54.

Digital processing is finalized at this stage and the signals are transmitted to an adaptation part for display. The adaptation operations consist mainly in adapting to the PAL or SECAM format, together with a digital/analog conversion at blocks 7a, 7b, 7c respectively.

At the output from 7b and 7c, an analog signal which can be used by television set 3 is obtained.

As described above, it is noted that the set top box currently used carries out the essential stages of the digital processing. This processing concerns the following stages in particular:
descrambling (consisting in obtaining a stream decoded by the authorization means delivered to the user by an operator).
decoding consisting in passing from a predetermined compression format such as MPEG2, MPEG4, or MP3 to a decompressed format.
The preliminary digital processing phases include demultiplexing of the digital transport stream and filtering of the data.

The module and the system of the present invention enable all or part of these essential digital processing stages to be performed remotely.

In this context, the invention system comprises a host 1 which may be used externally in a similar way to the set top box or decoders 50 used at present and conventionally consisting of a reception part 6 comprising a tuner 6a and a demodulator 6b as well as an adaptation part for display 7 including conventionally a format adapter 7a (for example PAUSECAM) and digital/analog converters 7b, 7c of video and audio signals. Host 1 also includes the various interface elements which allow the connection of tuner 6a, for instance aerial or terrestrial reception means, as well as a connection to a television set 3 output. Host 1 can moreover be operated by a remote control 9.

Characteristically, host 1 of the invention co acts with a processing module 2 which is also schematized on FIG. 3. The connection between processing module 2 and host 1 can be made in various ways, for example by means of a serial connection of the type USB.

An interface in host 1 manages the communications between host 1 and processing module 2. This is advantageously controlled by processing module 2 and is therefore entirely its slave.

FIG. 3 illustrates the routing of the data within the invention. In particular, the data from tuner 6a and from demodulator 6b reach interface 12 for transmission to processing module 2.

Thereafter, the treated data are returned by processing module 2 to host 1 once again by interface 12, for transmission to the adaptation part for display 7 and finally, use by television set 3.

FIG. 4 shows the processing of the digital signals that takes place within processing module 2 in greater detail.

This processing consists initially in decoding the digital signals contained in input transport stream 5 (taken from the operator broadcasting system) converting the data from a predetermined compression format (generally MPEG2) into a decompressed format.

Processing module 2 thus comprises decoding means 15, 16 returning an unscrambled stream 31 to host 1. After returning to host 1, an unscrambled video signal 36 and an unscrambled audio signal 37 can be delivered to the adaptation part 7 for display and sound audition.

In a beneficial way, and if the invention system is used to access paid television programmes, processing module 2 also includes descrambling means 13 capable of acting with means 14 authorizing the decryption which is specific to the user and the operator in order to descramble the stream delivered by the operator.

Block 13 also advantageously includes conventional pre-processing means consisting in prior filtering and demultiplexing of the input transport stream 5. Once the pre-processing and descrambling has taken place at block 13, the data are transmitted to the decoding means (audio decoder 16 and video decoder 15) also contained in processing module 2. This configuration is illustrated in FIG. 5.

As an indication, FIG. 6 is an example of processing module 2. In this context, module 2 includes the following elements: a controller 17, an authorization storage zone 18 (to house the decoding authorization means), a data storage zone 19 (consisting of DRAM type dynamic memory), a programme storage zone 20, a descrambling accelerator 21, filtering accelerator 22, decryption accelerator 23, audio decoding 24 and video decoding 25. Last of all, processing module 2 comprises a master interface 35 for communicating with host 1.

According to a preferred embodiment, the processing module also includes means 26, 27 for encoding digital signals which, after the decoding operation, encode digital signals in another compression format. This allows code conversion, for example MPEG2 format to MPEG4 format, or MPEG2 format to MP3 in the case of the audio signals in order to reduce their size significantly.

This code conversion operation enables data to be stored at storage unit 10. According to the example in FIG. 8, storage unit 10 is remote from processing module 2 and host 1. However, this solution is not limitative and integrated storage unit 10 could be either in host 1 or in the processing modules 2.

Moreover, storage unit 10 is also advantageously operated by the control means of module 2.

In the example given in FIG. 8, transport stream 5 received by host 1 (stage A) is transmitted by interface 12 to processing module 2 (stage B) in order to perform there decoding and then encoding for storage in storage unit 10 in a desired compression format (stages C and D). These phases of data transmission between the various components of the system are particularly identified A to D on FIG. 9.

When the user wants to display the data stored in storage unit 10, the schematic shown on FIG. 10 is executed. The stored data are retransmitted from storage unit 10 to interface 12 (stage A) for transmission to processing module 2 (stage B). At this level, the data are decoded for use by host 1 (stage C). In stage D, the signals are transmitted to the television set for viewing. In addition to the encoding and decoding operations by the processing module in this context of cooperation with storage unit 10, scrambling and descrambling operations can be used, especially for storage of scrambled data on a storage unit in order to avoid hacking.

FIG. 7 shows more precisely the means that can be used for local backup of the data on storage unit 10.

The assembly created can be used to generate signals to the required format. In order to ensure that the data are secured, key generator 30 is also present in order to transmit the local copy keys to the local encryption means 28 and local decryption means 29.

Thus, when the user wishes to make a local copy, the unscrambled video and audio signals 32, 33 are received at the video and audio encoders 26 and 27 for encoding to the desired format (for example MPEG4 and MP3). The signals thus compressed are received by local encryption means 28 where they are scrambled using the local encryption keys generated by generator 30. At the output, we obtain encoded and encrypted signals 38.

When the user wants to replay the data stored in this way, the encoded encrypted signals 34 are received at the input by local decryption means 29 suited to unscrambling by means of keys, then to transmission of the unscrambled signals to decoder 15, 16 in order to generate unscrambled and decompressed video and audio signals 36, 37 at the output.

A processing module 2 can integrate one or more encoding and decoding means according to the compression format which it is required to achieve, or which it is desired to decode.

According to a variant of the invention, the system consists of at least one additional processing module 11 also able to be connected to host 1 by interface 12. This configuration means in particular that only host 1 needs to have the various processing modules 2 corresponding to the various digital broadcasting operators.

By means of the invention, two streams (or more) of digital data can be processed simultaneously. This function will find application, for instance in the execution of Picture in Picture functions (consisting in inserting one image in another) or for storing the data corresponding to a programme while visualizing the data of another programme.

In this context, FIG. 11 is an example of simultaneously working on multiple streams in the case of the variant which uses two processing modules 11.

In this application, the first processing module 2 can for instance be used for decoding and encoding digital data towards or from format MPEG2. Additional processing module 11 is used to encode or decode digital data to the MPEG4 and MP3 formats.

In the context of the example in FIG. 11, a digital data stream 1 is received at the receiving part 6 of host 1 (stage A). Moreover, storage unit 10 transmits another stream corresponding to the stored data to interface 12 of host 1 (stage B). The input transport stream is transmitted by interface 12 to processing module 2 as shows the arrow marked C.

At the same time, the data emitted from the storage unit are transmitted by interface 12 to the additional processing module 11 as shows arrow D. In the additional processing module 11, the data are decoded in order to be returned as shows the arrow marked E to interface 12 for transmission to processing module 2 as shows the arrow marked F. Data from the stream identified by arrow C are processed in processing module 2 in order to be in particular de-multiplexed, filtered and descrambled (if necessary) and decoded from their initial compression format.

At this stage, processing module 2 has the unscrambled data from the input transport streams identified by arrow A and storage unit 10. All of these unscrambled digital signals can then be returned to interface 12 for use by host 1 as show the arrow marked G. This use can for example consist of a Picture in Picture type insertion on the screen, but this example is not limitative.

According to one eventual receiving and processing method of the invention, the digital data from an input transport stream 5 are stored on storage unit 10 for deferred retransmission to processing module 2 for data processing. This enables for instance a stream received directly on the storage unit to be stored, and the processing to be executed at the level of the module only later on (for example taking into account the processing time required for re-encoding, for working during a slack period, for example at night).

Thus, the stream received directly is stored in storage unit 10 and then returned to processing module 2 for compression and is finally returned compressed at the desired format to the storage unit. It is noted that, in this example the power of the module is less and this reduces the chip surface, the heat to be dissipated and the cost of the module.

According to another variant, the system comprises an digital/analog converter connected at the input to processing module 2, in order to allow associated processing of analog signals. For instance, this configuration allows processing module 2 to be connected to a terrestrial television source in analog format or to an analog data storage unit such as a video tape recorder.

This configuration also enables audio data from the analog receiving means to be received for instance on an hi fi system. The analog signals thus received at the input by processing module 2 are digitalized by the digital/analog converter and can be operated in addition to the digital data described previously in the context of the invention. In particular, processing module 2 can process data resulting from the analog signals in order to encode them for storage on storage unit 10.

### REFERENCES

1. host
2. processing module
3. television set
4. telecommunications network
5. input digital stream
6. reception part
6a. tuner
6b. demodulator
7. adaptation part for the display
7a. format adapter
7b. D/A video converter
7c. D/A audio converter
8. encoded/encrypted input signal
9. remote control
10. digital data storage unit
11. additional processing module
12. interface
13. descrambling means
14. decryption authorization means
15. video decoder
16. video decoder
17. controller
18. authorization storage zone
19. data storage zone
20. programme storage zone
21. descrambling accelerator
22. filtering accelerator
23. decryption accelerator
24. audio decoding accelerator
25. video decoding accelerator
26. video encoder
27. audio encoder
28. local encryption means
29. local decryption means
30. key generator
31. decompressed and unscrambled stream
32. unscrambled input video signal
33. unscrambled audio input signal
34. encrypted input signals
35. master interface
36. unscrambled video output signal
37. unscrambled audio output signal
38. encrypted output signal
50. decoder
51. smart card
52. smart card interface
53. audio decoder
54. video decoder
55. descrambler

1. Digital signals processing module (2) which can be connected to a host (1) for
receiving at least one input transport stream (5) of encoded digital data in a predetermined compression format,
Characterized in that,
it includes means for decoding (15, 16) the digital signals contained in the input
transport stream (5).

2. Module according to claim 1, characterized in that,
it includes means for descrambling (13) the scrambled digital signals contained in the input transport stream (5).

3. Module according to claim 2, characterized in that,
it includes means for authorizing the decryption.

4. Module according to claim 1, characterized in that,
it includes means for prior demultiplexing and filtering the input transport stream (5).

5. Module according to claim 1, characterized in that,
it includes means for encoding (26, 27) digital signals in at least another compression format, for code conversion.

6. Module according to claim 1, characterized in that,
it includes means for temporary or permanent storage of data signals.

7. Module according to claim 1, characterized in that,
it includes means for operating its interface (12) with host (1).

8. Module according to claim 1, characterized in that,
the input transport stream is a digital data stream transporting audiovisual programmes.

9. System for receiving and processing digital signals comprising a host (1) for receiving at least one transport stream (5) of encoded digital data in a predetermined compression format and a processing module (2) able to be connected to the host (1), characterized in that,
it includes a processing module (2) according to claim 1.

10. System according to claim 9, characterized in that, the host includes an interface (12) connecting with processing module (2), said interface (12) comprising a signal input emitted by a receiving part (6) of host (1) and a signal output towards a part (7) of host (1) for adapting the signal for display.

11. System according to claim 10, characterized in that,
interface (12) is operated by processing module (2).

12. System according to any claim 9, characterized in that,
it includes at least one additional processing module (11) which can be connected to host (1) by interface (12).

13. System according to claim 10, characterized in that,
it includes a digital data storage unit (10).

14. System according to claim 13 characterized in that,
storage unit (10) can be connected to host (1) by interface (12).

15. System according to claim 13, characterized in that,
processing module (2) includes local data encryption means for storage on the storage unit (10).

16. System according to claim 9, characterized in that,
It includes a digital/analog converter connected at the input to the processing module (2) for additional processing of analog signals.

17. Method for receiving and processing digital signals including a stage for host (1) to receive at least one input transport stream (5) for encoded digital data in a predetermined compression format, characterized in that,
the input transport stream (5) is transmitted from host (1) to a processing module (2)
digital signals contained in the input data stream (5) are decoded in the processing module (2);
the treated signals are returned to host (1).

18. Method according to claim 17, characterized in that,
demultiplexing and filtering of data input stream (5) take place in the processing module (2) before decoding.

19. Method according to claim 17, characterized in that,
scrambled digital signals are received in input transport stream (5);
the scrambled digital signals are descrambled in processing module (2).

20. Method according to claim 17, characterized in that,
a storage unit (10) is used to store digital data from the input transport stream (5).

21. Method according to claim 20, characterized in that,
the digital data from the input transport stream (5) is stored on storage unit (10);
the digital data is transmitted to processing module (2) for processing.

22. Method according to claim 20, characterized in that,
decoding of the digital data takes place in processing module (2), and then encoding in another data compression format,
this transcoded digital data is stored in storage unit (10).

23. Method according to claim 20, characterized in that,
the digital data of the treated signals is encrypted in the processing module (2);
the encrypted processed signals are stored on storage unit (10).

24. Method according to claim 17, characterized in that,
several input transport streams (5) are received;
the input transport streams (5) are transmitted towards processing module (2) for processing;
the treated signals are returned to host (1) for storage and/or display.

25. Method according to claim 17, characterized in that,
at least one additional processing module (11) is used,
decoding is carried out from different compression formats in the various processing modules (2, 11).
